(19) United States
(12) Patent Application Publication
(10) Pub. No.: US 2023/0171622 A1
(43) Pub. Date: Jun. 1, 2023

(54) STATE-BASED ANOMALY DETECTION TO ENABLE DIAGNOSTIC DATA COLLECTION FOR SPECIFIC SUBSCRIBERS IN CORE NETWORK NODES OF A TELECOMMUNICATIONS NETWORK

(71) Applicant: Microsoft Technology Licensing, LLC, Redmond, WA (US)

(72) Inventor: Devesh VERMA, Delhi (IN)

(21) Appl. No.: 17/538,212

(22) Filed: Nov. 30, 2021

(51) Int. Cl. H04W 24/08

(52) U.S. Cl. CPC H04W 24/08

(57) ABSTRACT

In a telecommunications network comprising a core network node for which different levels of diagnostic data can be collected, a method for selectively collecting additional diagnostic data associated with a subscriber can include obtaining an anomaly detection model. The anomaly detection model can comprise a plurality of high frequency state streams that indicate normal state transitions and a plurality of low frequency state streams that indicate at least one abnormal state transition. A state stream generated by an FSM in a core network node can be evaluated by the anomaly detection model to detect if it is anomalous. Additional diagnostic data associated with a subscriber can be collected based at least in part on a result of the evaluation indicating that an abnormal scenario has occurred.

### CROSS-REFERENCE TO RELATED APPLICATIONS

N/A

### BACKGROUND

Cellular networks are widely deployed to provide various communication services such as voice, text messaging, multimedia data, internet connectivity, and the like. Cellular networks can be multiple-access networks capable of supporting multiple users by sharing the available network resources.

A cellular network includes a radio access network (RAN) and a core network. The RAN and the core network function together to provide mobile devices with access to services available from one or more external packet data networks. Cellular networks are often used to provide Internet connectivity to mobile devices.

The RAN manages the radio spectrum, making sure it is used efficiently and meets users' quality-of-service (QoS) requirements. The RAN includes a plurality of base stations that communicate wirelessly with UEs and enable the UEs to wirelessly connect to the mobile network. A base station can provide wireless connectivity for UEs within a particular geographic area, which can be referred to as a “cell.”

The core network performs a variety of functions, including providing Internet protocol (IP) connectivity for both data and voice services, ensuring this connectivity fulfills the promised QoS requirements, ensuring that the UEs are properly authenticated, tracking user mobility to ensure uninterrupted service, and tracking subscriber usage for billing and charging.

Cellular networks have undergone significant changes over the past several decades. The first two generations of cellular networks supported voice and then text messaging. Third generation (3G) networks initiated the transition to broadband access, supporting data rates typically measured in hundreds of kilobits-per-second. Fourth generation (4G) networks supported data rates that were significantly faster, typically measured in megabits-per-second. Today, the industry is transitioning from 4G to fifth generation (5G) networks, with the promise of significant increases in data rates.

The 5G system architecture is significantly different from its predecessors in many respects. For example, in a 5G system, network management can be software driven, and network functions and resources can be virtualized at the edges and inside the network core. A 5G system implementation can be based on cloud-native applications, virtualized network functions, and microservices-based design patterns.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### SUMMARY

The present disclosure is generally related to a telecommunications network comprising a core network node for which different levels of diagnostic data can be collected. One aspect of the present disclosure is related to a method for selectively collecting additional diagnostic data associated with a subscriber in such a telecommunications network. The method comprises obtaining an anomaly detection model that comprises a plurality of state streams collected from a plurality of finite state machines in the core network node during a training period. The plurality of state streams comprise a plurality of high frequency state streams that indicate normal state transitions and a plurality of low frequency state streams that indicate at least one abnormal state transition. The method also comprises receiving a state stream generated by a finite state machine in the core network node. The finite state machine corresponds to the subscriber. The method also comprises providing the state stream as input to the anomaly detection model. The method also comprises causing the additional diagnostic data associated with the subscriber to be collected based at least in part on a result of an evaluation by the anomaly detection model indicating that an abnormal scenario has occurred. The additional diagnostic data is distinct from basic diagnostic data that is continuously collected for the core network node.

In some embodiments, the method can further comprise determining whether the state stream corresponds to any of the plurality of high frequency state streams or to any of the plurality of low frequency state streams in the anomaly detection model. The additional diagnostic data associated with the subscriber can be collected when the state stream corresponds to one of the low frequency state streams or when the state stream is a novel state stream.

In some embodiments, the method can further comprise receiving a low frequency state stream, determining which high frequency state stream among the plurality of high frequency state streams is closest to the low frequency state stream, and identifying a state transition window in the low frequency state stream where the low frequency state stream differs from the high frequency state stream. The collection of the additional diagnostic data can be activated in response to detecting the state transition window in the state stream generated by the finite state machine corresponding to the subscriber.

In some embodiments, the state transition window can comprise a first state field that indicates a first state of a finite state machine, a time field that indicates an amount of time that the finite state machine spends in the first state, and a second state field that indicates a second state of the finite state machine.

In some embodiments, the evaluation can be performed and the additional diagnostic data can be collected subsequent to the training period for the anomaly detection model.

In some embodiments, each state stream among the plurality of state streams can comprise a plurality of state-time pairs. Each state-time pair can comprise a state field that indicates a state of a finite state machine, and a time field that indicates an amount of time that the finite state machine spent in the state.

In some embodiments, the high frequency state streams can comprise state streams for which a number of occurrences in the plurality of state streams exceeds a threshold value.

In some embodiments, the low frequency state streams can comprise state streams for which a number of occurrences in the plurality of state streams is less than a threshold value.

Another aspect of the present disclosure is related to a system for selectively collecting additional diagnostic data associated with a subscriber in a telecommunications network comprising a core network node for which different levels of diagnostic data can be collected. The system comprises at least one processor, memory communicatively coupled to the at least one processor, and instructions stored in the memory. The instructions are executable by the at least one processor to obtain an anomaly detection model that comprises a plurality of state streams collected from a plurality of finite state machines in the core network node during a training period. The plurality of state streams comprise a plurality of high frequency state streams that indicate normal state transitions and a plurality of low frequency state streams that indicate at least one abnormal state transition. The instructions are also executable by the at least one processor to receive a state stream generated by a finite state machine in the core network node. The finite state machine corresponds to the subscriber. The instructions are also executable by the at least one processor to provide the state stream as input to the anomaly detection model, and to cause the additional diagnostic data associated with the subscriber to be collected based at least in part on a result of an evaluation by the anomaly detection model indicating that an abnormal scenario has occurred. The additional diagnostic data is distinct from basic diagnostic data that is continuously collected for the core network node.

In some embodiments, the system can further comprise additional instructions that are executable by the at least one processor to determine whether the state stream corresponds to any of the plurality of high frequency state streams or to any of the plurality of low frequency state streams in the anomaly detection model. The additional diagnostic data associated with the subscriber can be collected when the state stream corresponds to one of the low frequency state streams or when the state stream is a novel state stream.

In some embodiments, the system can further comprise additional instructions that are executable by the at least one processor to receive a low frequency state stream, determine which high frequency state stream among the plurality of high frequency state streams is closest to the low frequency state stream, and identify a state transition window in the low frequency state stream where the low frequency state stream differs from the high frequency state stream. The collection of the additional diagnostic data can be activated in response to detecting the state transition window in the state stream generated by the finite state machine corresponding to the subscriber.

In some embodiments, the state transition window can comprise a first state field that indicates a first state of a finite state machine, a time field that indicates an amount of time that the finite state machine spends in the first state, and a second state field that indicates a second state of the finite state machine.

In some embodiments, the evaluation can be performed and the additional diagnostic data can be collected subsequent to the training period for the anomaly detection model.

In some embodiments, each state stream among the plurality of state streams can comprise a plurality of state-time pairs. Each state-time pair can comprise a state field that indicates a state of a finite state machine, and a time field that indicates an amount of time that the finite state machine spent in the state.

In some embodiments, the high frequency state streams can comprise state streams for which a number of occurrences in the plurality of state streams exceeds a threshold value.

In some embodiments, the low frequency state streams can comprise state streams for which a number of occurrences in the plurality of state streams is less than a threshold value.

In accordance with another aspect of the present disclosure, a method for selectively collecting additional diagnostic data associated with a subscriber comprises obtaining an anomaly detection model that comprises a plurality of state streams collected from a plurality of finite state machines in the core network node during a training period. The plurality of state streams comprises a plurality of high frequency state streams that indicate normal state transitions and a plurality of low frequency state streams that indicate at least one abnormal state transition. The method further comprises receiving a state stream generated by a finite state machine in the core network node. The finite state machine corresponds to the subscriber. The method further comprises determining whether the state stream corresponds to any of the plurality of high frequency state streams or to any of the plurality of low frequency state streams in the anomaly detection model. The method further comprises causing the additional diagnostic data associated with the subscriber to be collected when the state stream corresponds to one of the low frequency state streams or when the state stream is a novel state stream.

In some embodiments, determining whether the state stream corresponds to any of the plurality of high frequency state streams or to any of the plurality of low frequency state streams in the anomaly detection model occurs subsequent to the training period for the anomaly detection model.

In some embodiments, each state stream among the plurality of state streams can comprise a plurality of state-time pairs. Each state-time pair can comprise a state field that indicates a state of a finite state machine, and a time field that indicates an amount of time that the finite state machine spent in the state.

In some embodiments, the high frequency state streams can comprise state streams for which the number of occurrences in the plurality of state streams exceeds the configured threshold for high frequency state streams. The low frequency state streams can comprise state streams for which the number of occurrences in the plurality of state streams is less than the configured threshold for low frequency state streams.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIGS. 1A and 1B illustrate an example of a system in which the techniques disclosed herein can be utilized, including a core network node with a plurality of FSMs and a plurality of state streams generated by the FSMs.

FIG. 2 illustrates an example of a state stream that comprises a plurality of state-time pairs.

FIG. 3 illustrates an example of a method for selectively collecting additional diagnostic data associated with a subscriber in a telecommunications network.

FIG. 4 illustrates an example of a method for using an anomaly detection model to determine whether additional diagnostic data associated with a subscriber should be collected when a state stream associated with the subscriber is received.

FIG. 5A illustrates an example of a table that maps the values of state fields to the information that those values represent.

FIG. 5B illustrates an example of a table that maps the values of time fields to the information that those values represent.

FIG. 5C illustrates an example of an anomaly detection model comprising a plurality of state streams collected from a plurality of FSMs.

FIGS. 5D-F illustrate examples of state streams that can be obtained from an FSM after the anomaly detection model has been generated.

FIG. 6 illustrates another example of a method for using an anomaly detection model to determine whether additional diagnostic data associated with a subscriber should be collected when a state stream associated with the subscriber is received.

FIG. 7 illustrates an example of a state transition window.

FIG. 8 illustrates certain components that can be included within a computing system that can be used to implement the actions and operations described herein.

### DETAILED DESCRIPTION

The core network nodes of cellular networks are CPU/memory intensive deployments. This is particularly true for 4G and 5G networks. The number of subscribers that can be supported for a certain level of capital expenditures (CAPEX) and operating expenses (OPEX) is directly proportional to how efficiently CPU/memory resources are used by the core network software. The CPU/memory tradeoff often impacts how much and how often diagnostics can be collected to root cause a problem.

Core telecommunications networks are complex systems and the interaction of multiple internal and external agents makes the nature of faults highly unpredictable. To root cause these highly unpredictable faults generally involves adding more diagnostics. This ties well with the CPU/memory optimization problem to create a deeply unsettling conundrum.

There are various workarounds that can be used to address this problem. For example, one approach is to add more statistics. However, there is a limit to the volume of statistics that can be stored and how often all the statistics can be observed. Another solution is subscriber specific logging or packet capture. However, in most scenarios it is hard to know beforehand which subscriber is going to run into issues. The only options that remain other than the preceding ones are getting a task core dump or running specific tools on a task when it is under the problem scenario. However, this is an unnecessary overhead for operations engineers.

In addition to these approaches, various machine learning-based solutions have been tried, but most of them work with too much data or too much traffic and are essentially standalone systems on top of actual core network deployments. It is likely that the CAPEX/OPEX for running these systems as compared to the value they create would create an adoption barrier for these systems.

The present disclosure is generally related to a low cost, state-based outlier detector, with low CPU and memory overhead, to aid in collection diagnostics and root causing of issues.

The techniques disclosed herein take advantage of the fact that at the heart of most telecommunications core software lies one or more finite-state machines. A finite-state machine (FSM) is a model of computation that can be in exactly one of a finite number of states at any given time. An FSM can change from one state to another in response to particular inputs. The majority of the software issues in a telecommunications network are either precipitated by incorrect FSM transitions or are reflected in abnormal FSM transitions. Therefore, performing anomaly detection on FSM states (e.g., their sequence of transitions and the time spent in each state) can provide a good trigger for the collection of debug diagnostics.

One aspect of the present disclosure is related to a telecommunications network comprising a core network node for which different levels of diagnostic data can be collected. For example, the present disclosure can be implemented in a telecommunications network in which basic diagnostic data is continuously collected, and additional diagnostic data (beyond the basic diagnostic data) is only collected under some circumstances. One reason why the additional diagnostic data is not always collected could be to save resources (e.g., compute resources).

The term “diagnostic data” can refer to any information that is related to (or can be used in connection with) diagnosing a problem related to a core network node of a telecommunications network. Some examples of diagnostic data include statistics, logs (which can be of different severity), alarms (which can be generated when certain thresholds are reached), and on-demand diagnostics (which can be collected through usage of tools, such as a core dump of a running process).

The term “basic diagnostic data” can refer to any diagnostic data that is collected continuously and/or at regular intervals. For example, basic diagnostic data can be collected by a monitoring framework on a regular basis. However, there is some diagnostic data (which may be referred to herein as “additional diagnostic data”) that cannot be collected at regular intervals simply because the amount of additional diagnostic data that would be generated through their regular collection will be huge. However, when a problem is encountered, that additional diagnostic data can be extremely useful. Because the additional diagnostic data cannot be collected at a regular interval, some type of trigger can be helpful to ensure that the additional diagnostic data gets collected when a problem is encountered.

The present disclosure proposes techniques for determining when the additional diagnostic data should be collected. In other words, the present disclosure proposes techniques for selectively collecting additional diagnostic data associated with a subscriber in a telecommunications network.

The techniques disclosed herein include the use of state streams generated by FSMs. A state stream generated by an FSM can include information about the states and state transitions of that FSM. In some embodiments, a state stream generated by an FSM can include a plurality of state-time pairs. Each state-time pair can include a state field that indicates a state of the FSM and a time field that indicates an amount of time that the FSM spent in the state.

State streams generated for an FSM for multiple subscribers can be used to generate an anomaly detection model. Different anomaly detection models may be used for different FSMs in case multiple FSMs are in use in the software. The plurality of state streams in an anomaly detection model can comprise a plurality of high frequency state streams (i.e., state streams that occur frequently) that indicate normal state transitions and a plurality of low frequency state streams (i.e., state streams that are unusual) that indicate one or more abnormal state transitions.

The anomaly detection model can be generated during a training period. Subsequent to the training period, the anomaly detection model can be used to determine when additional diagnostic data should be collected. For example, after the anomaly detection model has been generated, a state stream generated by an FSM in the core network node can be evaluated by the anomaly detection model for the FSM to detect if the string is anomalous. A decision can be made about whether additional diagnostic data should be collected based on the result of this evaluation. If the result of the evaluation indicates that an abnormal scenario has occurred, then a decision can be made to collect the additional diagnostic data. On the other hand, if the result of the evaluation does not indicate that an abnormal scenario has occurred, then a decision can be made to not collect the additional diagnostic data.

For example, in some embodiments, the state stream can be compared to the plurality of high frequency state streams and to the plurality of low frequency state streams in the anomaly detection model. Additional diagnostic data associated with the subscriber can be collected when the state stream corresponds to one of the low frequency state streams or when the state stream is a novel state stream.

As another example, for a particular low frequency state stream, a determination can be made about which high frequency state stream among the plurality of high frequency state streams is closest to the low frequency state stream. When the closest high frequency state stream is found, a state transition window can be identified in the low frequency state stream where the low frequency state stream differs from the high frequency state stream. In some embodiments, the state transition window can include three fields: a first state field that indicates a first state of the FSM that generated the state stream, a time field that indicates an amount of time that the finite state machine spends in the first state, and a second state field that indicates a second state of the FSM. The state transition window can then be used to trigger collection of additional diagnostic data for a specific subscriber when that same state transition window is detected in a state stream generated by an FSM corresponding to the subscriber.

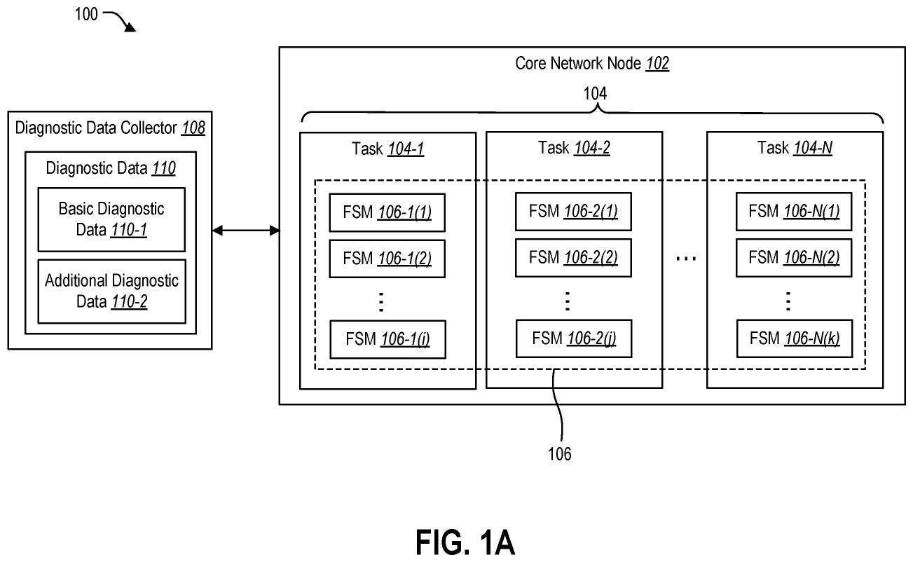

FIGS. 1A and 1B illustrate an example of a system 100 in which the techniques disclosed herein can be utilized. The system 100 can be implemented within a telecommunications network.

Reference is initially made to FIG. 1A. The system 100 includes a core network node 102. The core network node 102 can represent any component, module, unit, element, or segment of a core network within a telecommunications network. In some embodiments, the core network node 102 can be a network function. For example, the core network node 102 can be a packet gateway (PGW), serving gateway (SGW), session management function (SMF), and/or an access and mobility management function (AMF).

The core network node 102 includes a plurality of tasks 104. A first task 104-1, a second task 104-2, and an N^{th} task 104-N are shown in FIG. 1A. Each task 104 can represent a process that is executed by the core network node 102.

Each task 104 can include a plurality of FSMs 106. Each FSM 106 can correspond to a particular subscriber within the telecommunications network. For purposes of example, FIG. 1A shows the first task 104-1 with i FSMs 106-1(1), 106-1(2), . . . 106-1(i), the second task 104-2 with j FSMs 106-2(1), 106-2(2), . . . 106-2(j), and the N^{th} task with k FSMs 106-N(1), 106-N(2), . . . , 106-N(k). The values of i, j, k, and N can be any integer that is greater than or equal to one. The values of i, j, k, and N can be different from one another. Alternatively, some or all of the values of i, j, k, and N can be equal to one another.

For each subscriber, there are a certain set of transitions that each subscriber needs to go into. For example, after entering the network, a subscriber can go to an authentication server, wherein their credentials will get authenticated. After that they might go to a charging server and get some quota for their data transfer. All of these types of interactions can be regulated through an FSM 106.

The system 100 also includes a diagnostic data collector 108. The diagnostic data collector 108 can be configured to collect diagnostic data 110 about the core network node 102. The diagnostic data collector 108 can be configured to collect basic diagnostic data 110-1 on a continuous basis. The diagnostic data collector 108 can also be configured to collect additional diagnostic data 110-2 when it is determined that the additional diagnostic data 110-2 is needed.

FIG. 1B illustrates a plurality of state streams 112 generated by the FSMs 106-1(1), 106-1(2), . . . 106-1(i) in the task 104-1. In particular, FIG. 1B shows a state stream 112-1 generated by FSM 106-1(1), a state stream 112-2 generated by FSM 106-1(2), and a state stream 112-i generated by FSM 106-1(i). The other FSMs 106 in the core network node 102 can also generate similar state streams 112, although for the sake of simplicity this is not shown in FIG. 1B.

A state stream 112 generated by an FSM 106 can include information about the states and state transitions of that FSM 106. In the depicted embodiment, each state stream 112 comprises a plurality of state-time pairs 114. Each state-time pair 114 comprises a state field 116 that indicates a state of the corresponding FSM 106, and a time field 118 that indicates an amount of time that the FSM 106 spent in the state. Each block labeled “S” in FIG. 1B represents a state field 116, and each block labeled “T” in FIG. 1B represents a time field 118.

State streams 112 from the FSMs 106 can be used to generate an anomaly detection model 120. The period of time during which the state streams 112 are collected and used to generate the anomaly detection model 120 can be referred to as a training period. The anomaly detection model 120 can comprise a plurality of state streams 112 collected from a plurality of FSMs 106 in the core network node 102 during the training period.

The training period can last for a pre-determined time period. In some embodiments, the training period can last for at least one week to account for weekend/weekday traffic.

In some embodiments, a maximum capacity can be defined for a state stream 112. The maximum capacity can be defined in terms of a particular number of state transitions (e.g., M state transitions, where the value of M can be any integer greater than or equal to 1). A particular state stream 112 can be used for training whenever the corresponding subscriber has been deleted or whenever the maximum capacity of the state stream 112 has been reached.

The anomaly detection model 120 can comprise a plurality of high frequency state streams 122 and a plurality of low frequency state streams 124. In other words, the state streams 112 that are collected to form the anomaly detection model 120 can be sorted into high frequency state streams 122 and low frequency state streams 124. The high frequency state streams 122 are state streams that occur frequently and represent normal state transitions. Conversely, the low frequency state streams 124 are state streams that occur infrequently and represent at least one abnormal state transition. In some embodiments, the high frequency state streams 122 are state streams for which a number of occurrences exceeds a threshold value (e.g., an upper threshold value), and the low frequency state streams 124 are state streams for which a number of occurrences is less than a threshold value (e.g., a lower threshold value).

Once the anomaly detection model 120 has been generated, the anomaly detection model 120 can be used to determine when additional diagnostic data 110-2 should be collected. In some embodiments, after the anomaly detection model 120 has been generated, a state stream 112 generated by an FSM 106 in the core network node 102 can be evaluated by the anomaly detection model 120. A decision can be made about whether additional diagnostic data 110-2 should be collected based on the result of this evaluation.

For example, once the anomaly detection model 120 has been generated, a state stream 112 that is subsequently received from an FSM 106 corresponding to a particular subscriber can be compared to the high frequency state streams 122 and to the low frequency state streams 124 in the anomaly detection model 120. Additional diagnostic data 110-2 associated with the subscriber can be collected when the state stream 112 corresponds to one of the low frequency state streams 124 or when the state stream 112 is novel (i.e., when the state stream 112 does not correspond to any of the high frequency state streams 122 or to any of the low frequency state streams 124).

As another example, for a particular low frequency state stream 124, a determination can be made about which high frequency state stream 122 is closest to the low frequency state stream 124. When the closest high frequency state stream 122 is found, a state transition window can be identified in the low frequency state stream 124 where the low frequency state stream 124 differs from the high frequency state stream 122. The state transition window can then be used to trigger collection of additional diagnostic data 110-2 for a specific subscriber when that same state transition window is detected in a state stream 112 generated by an FSM 106 corresponding to the subscriber.

Various parameters (e.g., state stream size, training period, maximum entries of state streams in the detector, maximum number of times debug data generation is triggered for an error condition, and so forth) can be kept configurable for tuning and for keeping CPU usage optimum.

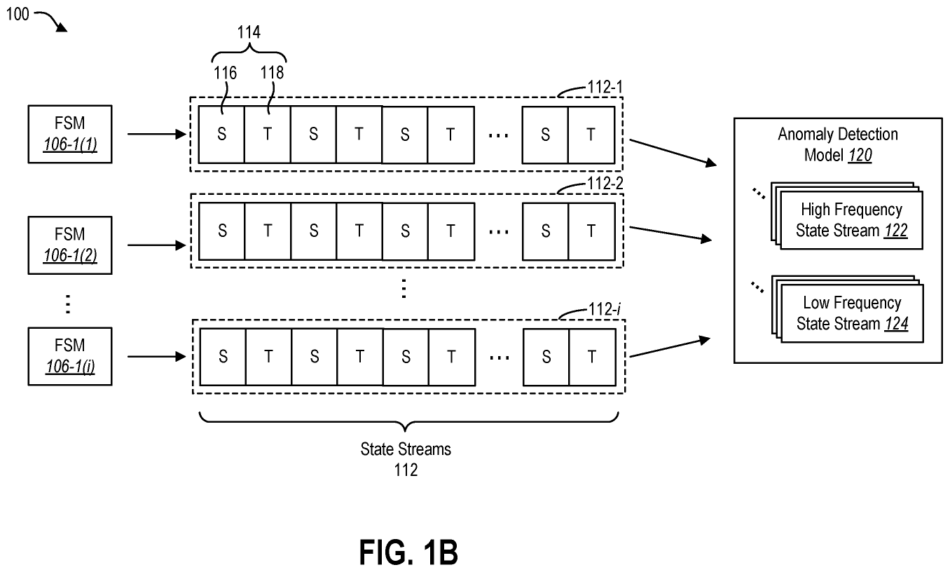

FIG. 2 illustrates an example of a state stream 212 that comprises a plurality of state-time pairs 214. In particular, the state stream 212 comprises N state-time pairs 214-1, 214-2, 214-3, 214-4, . . . 214-N, where the value of N can be any integer that is greater than or equal to one. Each state-time pair 214 comprises a state field 116 (as shown in FIG. 1) that indicates a state of the FSM that generated the state stream 212, and a time field 118 (as shown in FIG. 1) that indicates an amount of time that the FSM spent in the state.

For example, the first state-time pair 214-1 includes a state field 216-1 that indicates the first state that the FSM was in after the FSM started execution (which is identified as state 1), as well as a time field 218-1 that indicates how long the FSM spent in state 1. Similarly, the second state-time pair 214-2 includes a state field 216-2 that indicates the second state (which is identified as state 2) that the FSM transitioned to after being in state 1, as well as a time field 218-2 that indicates how long the FSM spent in state 2. The other state-time pairs 214-3, 214-4, . . . 214-N in the state stream 212 include similar information.

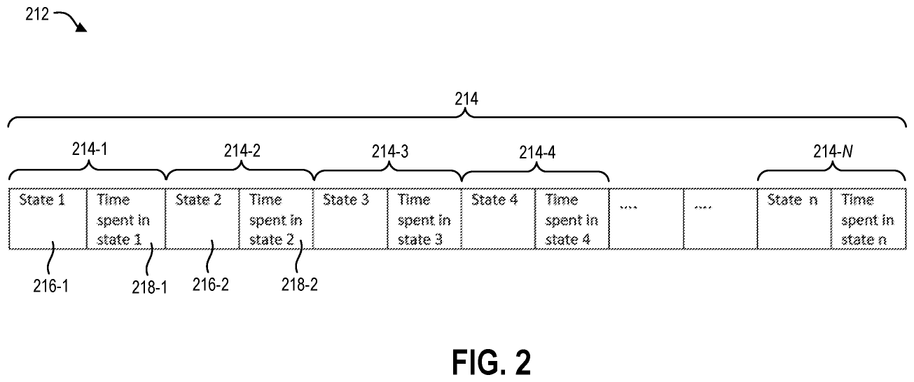

FIG. 3 illustrates an example of a method 300 for selectively collecting additional diagnostic data 110-2 associated with a subscriber in a telecommunications network. The method 300 will be described in relation to the system 100 shown in FIGS. 1A and 1B.

As shown, the first part of the method 300 (e.g., acts 301 through 307) can take place during a training period, while the second part of the method 300 (e.g., acts 309 through 313) can take place subsequent to the training period.

At 301, a plurality of state streams 112 are received from a plurality of FSMs 106 in the core network node 102.

At 303, a plurality of high frequency state streams 122 are identified among the plurality of state streams 112 that are received. As noted above, the high frequency state streams 122 are state streams that occur frequently and represent normal state transitions.

At 305, a plurality of low frequency state streams 124 are identified among the plurality of state streams 112 that are received. As noted above, the low frequency state streams 124 are state streams that occur infrequently and represent at least one abnormal state transition.

At 307, an anomaly detection model 120 is generated. The anomaly detection model 120 can comprise the plurality of high frequency state streams 122 that were identified at 303 as well as the plurality of low frequency state streams 124 that were identified at 305.

As noted above, acts 301 through 307 can occur during a training period. The remainder of the method 300 can occur subsequent to the training period.

At 309, a state stream 112 generated by an FSM 106 corresponding to a subscriber can be received. At 311, the state stream 112 and the anomaly detection model 120 can be used to determine whether additional diagnostic data 110-2 associated with the subscriber should be collected. More specifically, at 313, the state stream 112 received at 309 can be provided as input to the anomaly detection model 120, and the state stream 112 can be evaluated by the anomaly detection model 120 to detect whether the state stream 112 is anomalous. Some examples of how this evaluation can be performed will be described below. Where the result of the evaluation indicates that an abnormal scenario has occurred, then at 315 additional diagnostic data 110-2 associated with the subscriber can be collected.

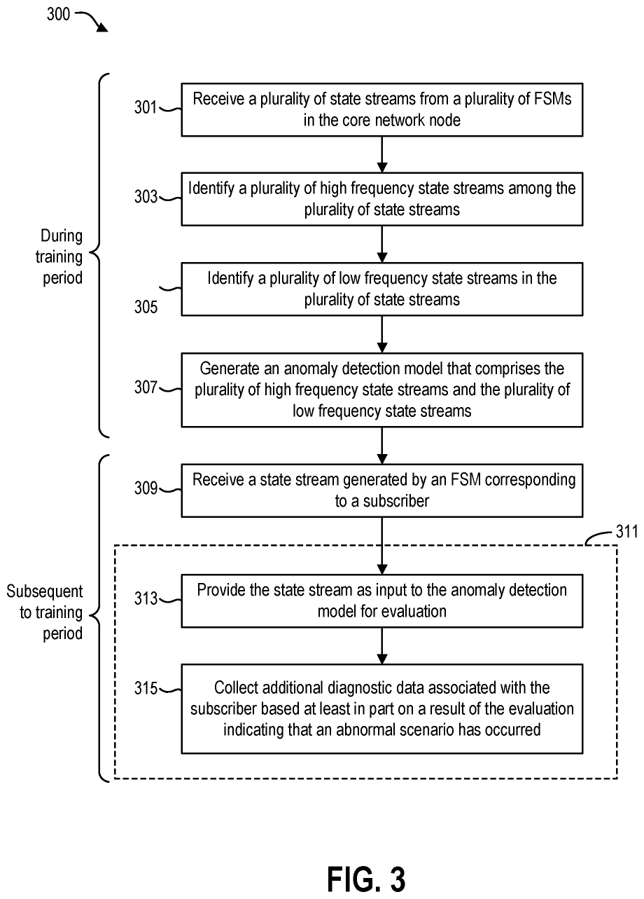

FIG. 4 illustrates an example of a method 400 for using the anomaly detection model 120 to determine whether additional diagnostic data 110-2 associated with a subscriber should be collected when a state stream 112 associated with the subscriber is received. In other words, the depicted method 400 is an example of one way that act 311 (including acts 313 and 315) in the method 300 shown in FIG. 3 can be implemented.

At 401, a state stream 112 generated by an FSM 106 corresponding to a subscriber can be received.

At 403, a determination can be made about whether the state stream 112 corresponds to any of the high frequency state streams 122 in the anomaly detection model 120. As noted above, the high frequency state streams 122 are state streams that occur frequently and include normal state transitions. Therefore, if it is determined that the state stream 112 received at 401 corresponds to a high frequency state stream 122 in the anomaly detection model 120, then this can be interpreted as an indication that the state stream 112 probably does not include any abnormal state transitions. Therefore, at 405, a determination can be made to not collect the additional diagnostic data 110-2 for the subscriber.

If at 403 it is determined that the state stream 112 does not correspond to a high frequency state stream 122 in the anomaly detection model 120, then the method 400 can proceed to 407. At 407, a determination can be made about whether the state stream 112 corresponds to any of the low frequency state streams 124 in the anomaly detection model 120. As noted above, the low frequency state streams 124 are state streams that occur infrequently and include at least one abnormal state transition. Therefore, if it is determined that the state stream 112 corresponds to a low frequency state stream 124 in the anomaly detection model 120, then this can be interpreted as an indication that the state stream 112 probably includes at least one abnormal state transition. Therefore, at 409, a determination can be made to collect the additional diagnostic data 110-2 for the subscriber.

If at 407 it is determined that the state stream 112 does not correspond to a low frequency state stream 124 in the anomaly detection model 120, then the method 400 can proceed to 411. At 411 it can be determined that the state stream 112 is novel, because the state stream 112 does not correspond to any of the high frequency state streams 122 or to any of the low frequency state streams 124. Because the state stream 112 is novel, then at 413 a determination can be made to collect the additional diagnostic data 110-2 for the subscriber.

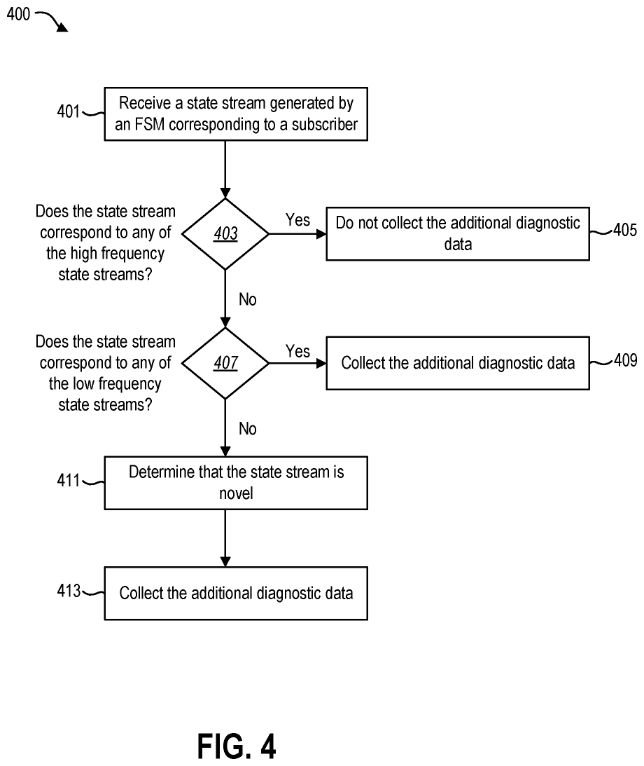

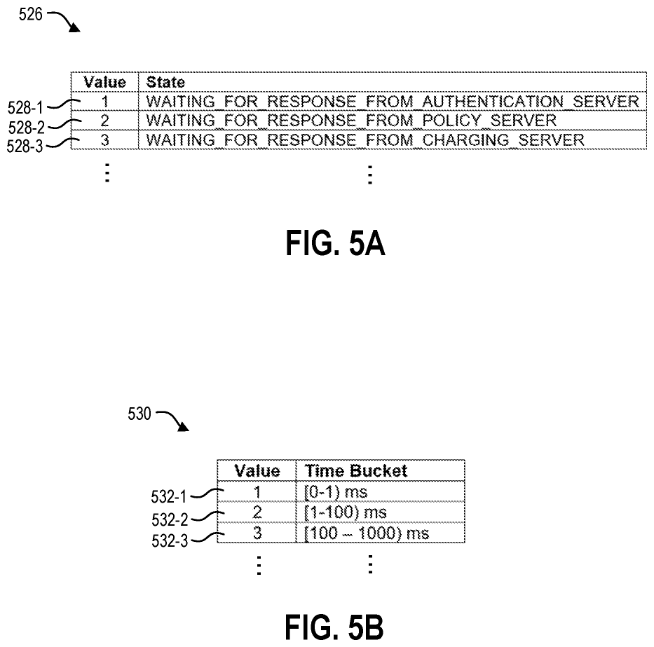

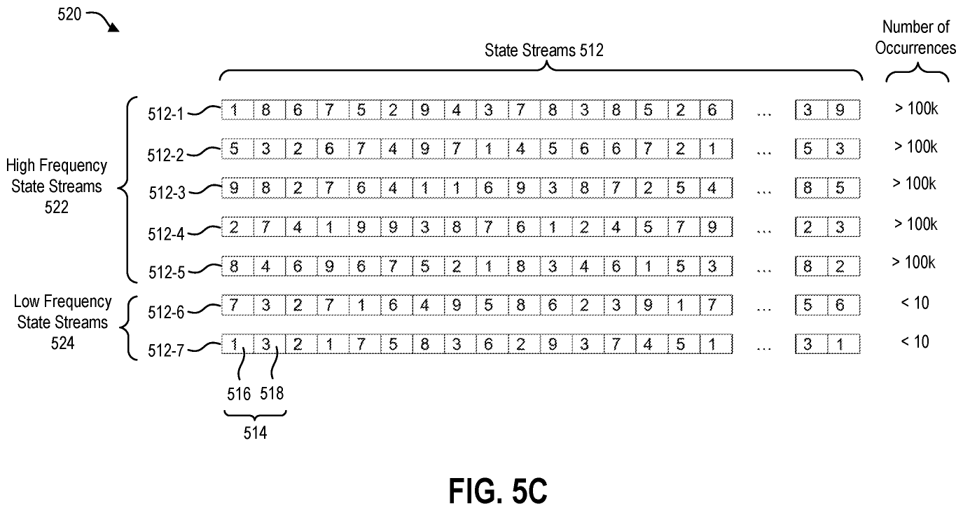

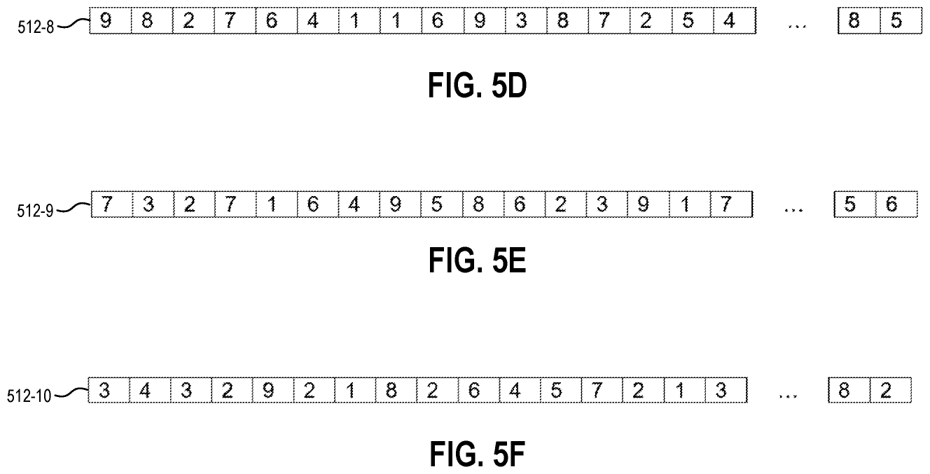

A specific example of the methods 300, 400 shown in FIGS. 3 and 4 will now be described in relation to FIGS. 5A-F.

FIG. 5A illustrates an example of a table 526 that maps the values of state fields 116 (as shown in FIG. 1) to the information that those values represent. For example, the table 526 includes a row 528-1 that maps the value of “1” to the state “WAITING_FOR_RESPONSE_FROM_AUTHENTICATION_SERVER”. Thus, in the depicted embodiment, if a particular state field 116 in a particular state stream 112 includes a value of “1”, this means that the FSM that generated the state stream 112 was in the state “WAITING_FOR_RESPONSE_FROM_AUTHENTICATION_SERVER”.

The table 526 also includes a row 528-2 that maps the value of “2” to the state “WAITING_FOR_RESPONSE_FROM_POLICY_SERVER”, a row 528-3 that maps the value of “3” to the state “WAITING_FOR_RESPONSE_FROM_CHARGING_SERVER”, and so forth.

FIG. 5B illustrates an example of a table 530 that maps the values of the time fields 118 (as shown in FIG. 1) to the information that those values represent. For example, the table 530 includes a row 532-1 that maps the value of “1” to any time period that is greater than or equal to 0 ms and less than 1 ms. Thus, in the depicted embodiment, if a particular time field 118 in a particular state stream 112 includes a value of “1”, this means that the FSM that generated the state stream 112 was in the state represented by the corresponding state field 116 for a period of time that is greater than or equal to 0 ms and less than 1 ms.

The table 530 also includes a row 532-2 that maps the value of “2” to any time period that is greater than or equal to 1 ms and less than 100 ms, a row 532-3 that maps the value of “3” to any time period that is greater than or equal to 100 ms and less than 1000 ms, and so forth.

Some examples using the values in the tables 526, 530 shown in FIGS. 5A and 5B will now be described. Suppose that the value of a state field 116 in a state stream 112 is “2”, and the value of a corresponding time field 118 is “1”. In the depicted embodiment, this means that the FSM that generated the state stream 112 was in the state “WAITING_FOR_RESPONSE_FROM_POLICY_SERVER” for a period of time that is greater than or equal to 0 ms and less than 1 ms.

As another example, suppose that the value of a state field 116 in a state stream 112 is “3”, and the value of a corresponding time field 118 is “2”. In the depicted embodiment, this means that the FSM that generated the state stream 112 was in the state “WAITING_FOR_RESPONSE_FROM_CHARGING_SERVER” for a period of time that is greater than or equal to 1 ms and less than 100 ms.

As another example, suppose that the value of a state field 116 in a state stream 112 is “2”, and the value of a corresponding time field 118 is “3”. In the depicted embodiment, this means that the FSM that generated the state stream 112 was in the state “WAITING_FOR_RESPONSE_FROM_POLICY_SERVER” for a period of time that is greater than or equal to 100 ms and less than 1000 ms.

For the sake of simplicity, only three rows are shown in the tables 526, 530 depicted in FIGS. 5A and 5B. Thus, the table 526 shown in FIG. 5A includes information for three possible states, and the table 530 shown in FIG. 5B includes information for three possible time buckets (or time intervals). However, one skilled in the art will appreciate that the tables 526, 530 can include many more than three rows. In other words, the table 526 shown in FIG. 5A can include information for many more than three possible states, and the table 530 shown in FIG. 5B can include information for many more than three possible time intervals.

In some embodiments, the value of each state field 116 and the value of each time field 118 can be represented using one byte of data. This enables 255 states and 255 time buckets (or time intervals) to be represented.

FIG. 5C illustrates an example of an anomaly detection model 520 comprising a plurality of state streams 512 collected from a plurality of FSMs. For the sake of simplicity, the anomaly detection model 520 only includes seven state streams 512-1, 512-2, 512-3, 512-4, 512-5, 512-6, 512-7. However, one skilled in the art will appreciate that an anomaly detection model that is created in accordance with the techniques disclosed herein can include many more state streams.

Each of the depicted state streams 512 includes a plurality of state-time pairs, which are similar to the state-time pairs described previously. For example, consider the state-time pair 514 in the state stream 512-7. This state-time pair 514 includes a state field 516 having a value of “1”, and a time field 518 having a value of “3”. Thus, based on the tables 526, 530 shown in FIGS. 5A and 5B, respectively, this state-time pair 514 means that the FSM that generated the state stream 512-7 was in the state “WAITING_FOR_RESPONSE_FROM_AUTHENTICATION_SERVER” for a period of time that is greater than or equal to 100 ms and less than 1000 ms.

The anomaly detection model 520 comprises a plurality of high frequency state streams 522 and a plurality of low frequency state streams 524. The high frequency state streams 522 are state streams 512 that occur frequently and represent normal state transitions. Conversely, the low frequency state streams 524 are state streams 512 that occur infrequently and represent at least one abnormal state transition. In the depicted embodiment, the high frequency state streams 522 are state streams for which a number of occurrences exceeds an upper threshold value, and the low frequency state streams 524 are state streams for which a number of occurrences is less than a lower threshold value. For the sake of example, FIG. 5C depicts the upper threshold value as 100k, and the lower threshold value as 10. However, these values are provided for purposes of example only, and they should not be interpreted as limiting the scope of the present disclosure.

In the depicted example, the state streams 512-1, 512-2, 512-3, 512-4, 512-5 have each occurred more than 100 k times during the collection of state streams 512 from FSMs during the training period. Thus, these state streams 512-1, 512-2, 512-3, 512-4, 512-5 are classified as high frequency state streams 522. Conversely, the state streams 512-6, 512-7 have each occurred fewer than 10 times during the collection of state streams 512 from FSMs during the training period. Thus, these state streams 512-6, 512-7 are classified as low frequency state streams 524.

FIGS. 5D-F illustrate examples of state streams 512-8, 512-9, 512-10 that can be obtained from an FSM after the anomaly detection model 520 has been generated. The state streams 512-8, 512-9, 512-10 can be processed in the manner described above in connection with the method 400 shown in FIG. 4. In other words, the state streams 512-8, 512-9, 512-10 can be compared to the state streams 512-1, 512-2, 512-3, 512-4, 512-5, 512-6, 512-7 in the anomaly detection model 520 to determine whether additional diagnostic data 110-2 should be collected.

For example, consider the state stream 512-8 shown in FIG. 5D. This state stream 512-8 is identical to the state stream 512-3 in the anomaly detection model 520. Because the state stream 512-3 is a high frequency state stream 522, a determination can be made that the state stream 512-8 corresponds to a high frequency state stream 522 (as in act 403 of the method 400). Therefore, a determination can be made to not collect the additional diagnostic data 110-2 for the subscriber (as in act 405 of the method 400).

As another example, consider the state stream 512-9 shown in FIG. 5E. This state stream 512-9 is identical to the state stream 512-6 in the anomaly detection model 520. Because the state stream 512-6 is a low frequency state stream 522, a determination can be made that the state stream 512-9 corresponds to a low frequency state stream 524 (as in act 407 of the method 400). Therefore, a determination can be made to collect the additional diagnostic data 110-2 for the subscriber (as in act 409 of the method 400).

As another example, consider the state stream 512-10 shown in FIG. 5F. This state stream 512-10 is different from all of the state streams 512-1, 512-2, 512-3, 512-4, 512-5, 512-6, 512-7 in the anomaly detection model 520. Therefore, a determination can be made that the state stream 512-10 is novel (as in act 411 of the method 400). Thus, a determination can be made to collect the additional diagnostic data 110-2 for the subscriber (as in act 413 of the method 400).

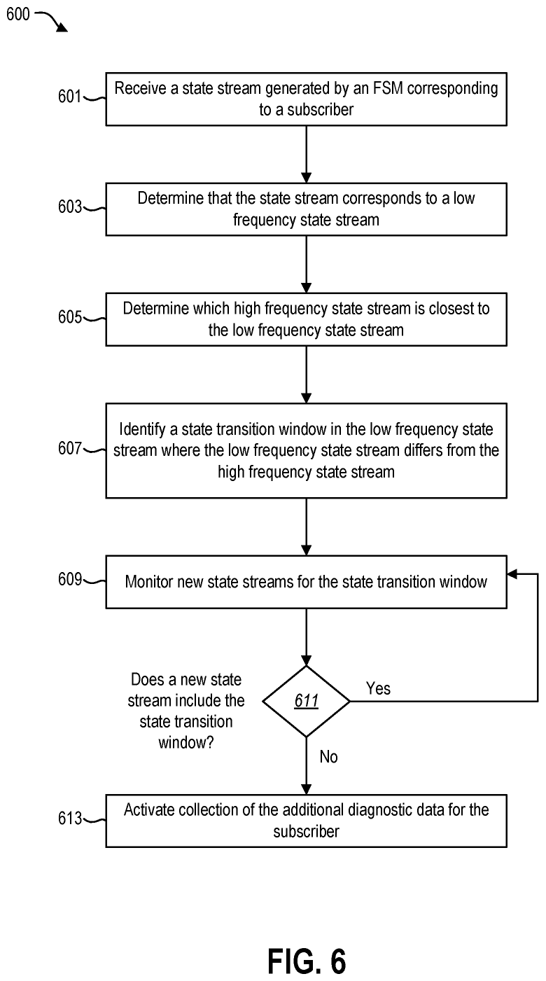

FIG. 6 illustrates another example of a method 600 for using the anomaly detection model 120 to determine whether additional diagnostic data 110-2 associated with a subscriber should be collected when a state stream 112 associated with the subscriber is received. In other words, the depicted method 600 is an example of another way that act 311 (including acts 313 and 315) in the method 300 shown in FIG. 3 can be implemented.

At 601, a state stream 112 generated by an FSM 106 corresponding to a subscriber can be received. At 603, a determination can be made that the state stream 112 corresponds to a low frequency state stream 124 in the anomaly detection model 120.

At 605, a determination can be made about which high frequency state stream 122 is closest to the low frequency state stream 124. There are various ways that this determination can be performed. In some embodiments, this determination can be performed with a simple sequence match to a first point of divergence. Consider a simple example in which the high frequency state streams are as follows:

HIGH FREQUENCY STATE STREAM #1

| | | | | | | | | |
|---|---|---|---|---|---|---|---|---|
| State 1 | 1 | State 2 | 2 | State 3 | 1 | State 4 | 3 | . . . |

HIGH FREQUENCY STATE STREAM #2

| | | | | | | | | |
|---|---|---|---|---|---|---|---|---|
| State 1 | 1 | State 2 | 2 | State 3 | 1 | State 4 | 5 | . . . |

HIGH FREQUENCY STATE STREAM #3

| | | | | | | | | |
|---|---|---|---|---|---|---|---|---|
| State 1 | 1 | State 2 | 5 | State 3 | 1 | State 4 | 3 | . . . |

Further suppose that the low frequency state stream is as follows:

LOW FREQUENCY STATE STREAM

| | | | | | | | | |
|---|---|---|---|---|---|---|---|---|
| State 1 | 1 | State 2 | 5 | State 3 | 1 | State 4 | 3 | . . . |

In this example, high frequency state stream #3 would be chosen as the high frequency state stream 122 that is closest to the low frequency state stream 124. In other words, in this example, the high frequency state stream 122 with the longest length until the point of divergence will be considered as closest to the low frequency state stream 124 (or novel state stream).

In alternative embodiments, the determination about which high frequency state stream 122 is closest to the low frequency state stream 124 can be made in other ways, such as by determining the Hamming distance between the low frequency state stream 124 and each of the high frequency state streams 122.

At 607, a state transition window can be identified where the low frequency state stream 124 differs from the high frequency state stream 122. In some embodiments, the state transition window can include three fields: a first state field that indicates a first state of the FSM that generated the low frequency state stream 124, a time field that indicates an amount of time that the FSM spends in the first state, and a second state field that indicates a second state of the FSM. A specific example of a state transition window will be described below.

At 609, new state streams 112 can be monitored for the state transition window that is identified at 607. At 611, whenever a new state stream 112 is received, a determination can be made about whether the new state stream 112 includes the state transition window. When it is determined that a new state stream 112 includes the state transition window, then at 613 the collection of the additional diagnostic data 110-2 for the corresponding subscriber can be activated.

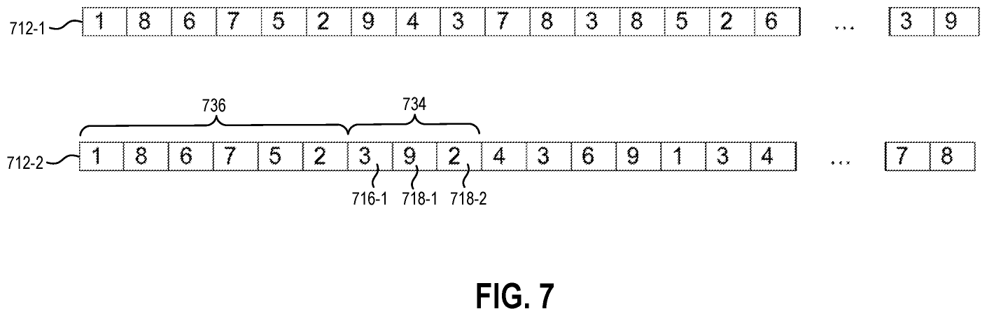

FIG. 7 illustrates an example of a state transition window 734. More specifically, FIG. 7 illustrates two state streams 712-1, 712-2. For purposes of the present example, it will be assumed that the state stream 712-1 is a high frequency state stream 122 in an anomaly detection model 120, and that the state stream 712-2 is a low frequency state stream 124 in the anomaly detection model 120. The state transition window 734 represents a portion of the state stream 712-2 (i.e., the low frequency state stream 124) that differs from the state stream 712-1 (i.e., the high frequency state stream 122).

More specifically, a first portion 736 of the state stream 712-2 is identical to the corresponding portion of the state stream 712-1. The state transition window 724 is the first portion of the state stream 712-2 that differs from the corresponding portion of the state stream 712-1. In the depicted embodiment, the state transition window 734 includes three elements: a first state field 716-1, a time field 718-1, and a second state field 718-2. The first state field 716-1 indicates a first state of the FSM that generated the state stream 712-2. The time field 718-1 indicates an amount of time that the FSM spends in the first state. The second state field 718-2 indicates a second state of the FSM that generated the state stream 712-2.

As described above in connection with the method 600 shown in FIG. 6, new state streams 112 can be monitored for the state transition window 734. Whenever the state transition window 734 is detected in a new state stream, the additional diagnostic data 110-2 can be collected. In the depicted embodiment, the additional diagnostic data 110-2 can be collected whenever a three element sequence matching the first state field 716-1, the time field 718-1, and the second state field 718-2 is detected.

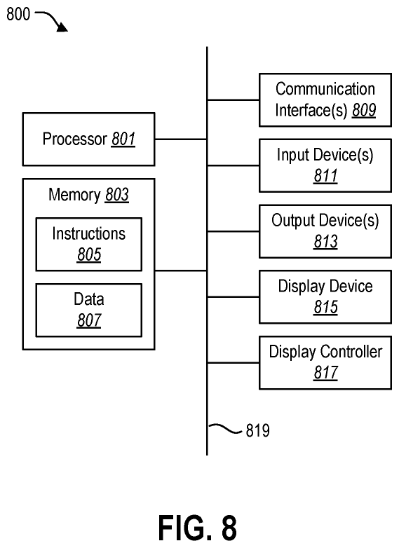

FIG. 8 illustrates certain components that can be included within a computing system 800 that can be used to implement the actions and operations described herein. In some embodiments, a plurality of computing systems 800 can collectively implement the actions and operations described herein.

The computing system 800 includes a processor 801 and memory 803 in electronic communication with the processor 801. Instructions 805a and data 807a can be stored in the memory 803. The instructions 805a can be executable by the processor 801 to implement some or all of the methods, steps, operations, actions, or other functionality disclosed herein. Executing the instructions 805a can involve the use of the data 807a that is stored in the memory 803. When the processor 801 executes the instructions 805a, various instructions 805b can be loaded onto the processor 801, and various pieces of data 807b can be loaded onto the processor 801.

Unless otherwise specified, any of the various examples of modules and components described herein can be implemented, partially or wholly, as instructions 805a stored in memory 803 and executed by the processor 801. Any of the various examples of data described herein can be among the data 807a that is stored in memory 803 and used during execution of the instructions 805a by the processor 801.

Although just a single processor 801 and a single memory 803 are shown in the computing system 800 of FIG. 8, in an alternative configuration, a combination of processors and/or a combination of memory devices could be used.

The instructions 805a in the memory 803 can be executable by the processor 801 to perform some or all aspects of the methods that have been described herein. The data 807a stored in the memory 803 can include any of the various examples of data described herein, including any data that is stored, accessed, or otherwise used in connection with the methods that have been described herein.

The computing system 800 can also include various other components, including one or more communication interfaces 809, one or more input devices 811, and one or more output devices 813.

The communication interface(s) 809 can be configured to communicate with other computing systems and/or networking devices. This includes receiving data transmissions from other computing systems and/or networking devices, and also sending data transmissions to other computing systems and/or networking devices. The communication interface(s) 809 can be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The various components of the computing system 800 can be coupled together by one or more buses, which can include a power bus, a control signal bus, a status signal bus, a data bus, etc. For simplicity, the various buses are illustrated in FIG. 8 as a bus system 819.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “communicatively coupled” refers to coupling of components such that these components are able to communicate with one another through, for example, wired, wireless, or other communications media. The term “communicatively coupled” can include direct, communicative coupling as well as indirect or “mediated” communicative coupling. For example, a component A may be communicatively coupled to a component B directly by at least one communication pathway, or a component A may be communicatively coupled to a component B indirectly by at least a first communication pathway that directly couples component A to a component C and at least a second communication pathway that directly couples component C to component B. In this case, component C is said to mediate the communicative coupling between component A and component B.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The phrase “based on” does not mean “based only on,” unless expressly specified otherwise. In other words, the phrase “based on” describes both “based only on” and “based at least on.”

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a telecommunications network comprising a core network node for which different levels of diagnostic data can be collected, a method for selectively collecting additional diagnostic data associated with a subscriber, the method comprising:
obtaining an anomaly detection model that comprises a plurality of state streams collected from a plurality of finite state machines in the core network node during a training period, wherein the plurality of state streams comprise a plurality of high frequency state streams that indicate normal state transitions and a plurality of low frequency state streams that indicate at least one abnormal state transition;
receiving a state stream generated by a finite state machine in the core network node, the finite state machine corresponding to the subscriber;
providing the state stream as input to the anomaly detection model; and
causing the additional diagnostic data associated with the subscriber to be collected based at least in part on a result of an evaluation by the anomaly detection model indicating that an abnormal scenario has occurred, wherein the additional diagnostic data is distinct from basic diagnostic data that is continuously collected for the core network node.

2. The method of claim 1, wherein:
the method further comprises determining whether the state stream corresponds to any of the plurality of high frequency state streams or to any of the plurality of low frequency state streams in the anomaly detection model; and
the additional diagnostic data associated with the subscriber is collected when the state stream corresponds to one of the low frequency state streams or when the state stream is a novel state stream.

3. The method of claim 1, further comprising:
receiving a low frequency state stream;
determining which high frequency state stream among the plurality of high frequency state streams is closest to the low frequency state stream; and
identifying a state transition window in the low frequency state stream where the low frequency state stream differs from the high frequency state stream, wherein the collection of the additional diagnostic data is activated in response to detecting the state transition window in the state stream generated by the finite state machine corresponding to the subscriber.

4. The method of claim 3, wherein the state transition window comprises:
a first state field that indicates a first state of a finite state machine;
a time field that indicates an amount of time that the finite state machine spends in the first state; and
a second state field that indicates a second state of the finite state machine.

5. The method of claim 1, wherein the evaluation is performed and the additional diagnostic data is collected subsequent to the training period for the anomaly detection model.

6. The method of claim 1, wherein each state stream among the plurality of state streams comprises a plurality of state-time pairs, and wherein each state-time pair comprises:
a state field that indicates a state of a finite state machine; and
a time field that indicates an amount of time that the finite state machine spent in the state.

7. The method of claim 1, wherein the high frequency state streams are state streams for which a number of occurrences in the plurality of state streams exceeds a threshold value.

8. The method of claim 1, wherein the low frequency state streams are state streams for which a number of occurrences in the plurality of state streams is less than a threshold value.

9. A system for selectively collecting additional diagnostic data associated with a subscriber in a telecommunications network, the telecommunications network comprising a core network node for which different levels of diagnostic data can be collected, the system comprising:
at least one processor;
memory communicatively coupled to the at least one processor; and
instructions stored in the memory, the instructions being executable by the at least one processor to:
obtain an anomaly detection model that comprises a plurality of state streams collected from a plurality of finite state machines in the core network node during a training period, wherein the plurality of state streams comprise a plurality of high frequency state streams that indicate normal state transitions and a plurality of low frequency state streams that indicate at least one abnormal state transition;
receive a state stream generated by a finite state machine in the core network node, the finite state machine corresponding to the subscriber;
provide the state stream as input to the anomaly detection model; and
cause the additional diagnostic data associated with the subscriber to be collected based at least in part on a result of an evaluation by the anomaly detection model indicating that an abnormal scenario has occurred, wherein the additional diagnostic data is distinct from basic diagnostic data that is continuously collected for the core network node.

10. The system of claim 9, wherein:
the system further comprises additional instructions that are executable by the at least one processor to determine whether the state stream corresponds to any of the plurality of high frequency state streams or to any of the plurality of low frequency state streams in the anomaly detection model; and
the additional diagnostic data associated with the subscriber is collected when the state stream corresponds to one of the low frequency state streams or when the state stream is a novel state stream.

11. The system of claim 9, further comprising additional instructions that are executable by the at least one processor to:
receive a low frequency state stream;
determine which high frequency state stream among the plurality of high frequency state streams is closest to the low frequency state stream; and
identify a state transition window in the low frequency state stream where the low frequency state stream differs from the high frequency state stream, wherein the collection of the additional diagnostic data is activated in response to detecting the state transition window in the state stream generated by the finite state machine corresponding to the subscriber.

12. The system of claim 11, wherein the state transition window comprises:
a first state field that indicates a first state of a finite state machine;
a time field that indicates an amount of time that the finite state machine spends in the first state; and
a second state field that indicates a second state of the finite state machine.

13. The system of claim 9, wherein the evaluation is performed and the additional diagnostic data is collected subsequent to the training period for the anomaly detection model.

14. The system of claim 9, wherein each state stream among the plurality of state streams comprises a plurality of state-time pairs, and wherein each state-time pair comprises:
a state field that indicates a state of a finite state machine; and
a time field that indicates an amount of time that the finite state machine spent in the state.

15. The system of claim 9, wherein the high frequency state streams are state streams for which a number of occurrences in the plurality of state streams exceeds a threshold value.

16. The system of claim 9, wherein the low frequency state streams are state streams for which a number of occurrences in the plurality of state streams is less than a threshold value.

17. In a telecommunications network comprising a core network node for which different levels of diagnostic data can be collected, a method for selectively collecting additional diagnostic data associated with a subscriber, the method comprising:
obtaining an anomaly detection model that comprises a plurality of state streams collected from a plurality of finite state machines in the core network node during a training period, wherein the plurality of state streams comprise a plurality of high frequency state streams that indicate normal state transitions and a plurality of low frequency state streams that indicate at least one abnormal state transition;
receiving a state stream generated by a finite state machine in the core network node, the finite state machine corresponding to the subscriber;
determining whether the state stream corresponds to any of the plurality of high frequency state streams or to any of the plurality of low frequency state streams in the anomaly detection model; and
causing the additional diagnostic data associated with the subscriber to be collected when the state stream corresponds to one of the low frequency state streams or when the state stream is a novel state stream.

18. The method of claim 17, wherein determining whether the state stream corresponds to any of the plurality of high frequency state streams or to any of the plurality of low frequency state streams in the anomaly detection model occurs subsequent to the training period for the anomaly detection model.

19. The method of claim 17, wherein each state stream among the plurality of state streams comprises a plurality of state-time pairs, and wherein each state-time pair comprises:
a state field that indicates a state of a finite state machine; and
a time field that indicates an amount of time that the finite state machine spent in the state.

20. The method of claim 17, wherein:
the high frequency state streams are state streams for which the number of occurrences in the plurality of state streams exceeds the configured threshold for high frequency state streams; and
the low frequency state streams are state streams for which the number of occurrences in the plurality of state streams is less than the configured threshold for low frequency state streams.
